(19) United States
(12) Patent Application Publication
(10) Pub. No.: US 2007/0281062 A1
(43) Pub. Date: Dec. 6, 2007

(54) Process for Neutralizing Enzymes in Corn

(76) Inventor: Wilfred Marcellien Bourg, Melissa, TX (US)

Correspondence Address: CARSTENS & CAHOON, LLP, P O BOX 802334, DALLAS, TX, 75380, US

(21) Appl. No.: 11/421,656

(22) Filed: Jun. 1, 2006

(51) Int. Cl. A23C 3/00

(52) U.S. Cl. 426/523; 426/518

(57) ABSTRACT

A method of making an enhanced corn masa by roasting corn kernels to neutralize the corn seed prior to cooking and soaking the corn in lime. Roasting of the corn kernels provides numerous benefits including the ability to dial in a roasted flavor with the use of blends of roasted and unroasted kernels, a higher conversion of the corn kernel into a finished product, a reduced acrylamide content in finished product, and fewer off-flavors in baked products.

### BACKGROUND OF THE INVENTION

The present invention relates to making an enhanced food product having consistent flavor and texture properties, a reduced level of acrylamide, and a greater conversion of raw materials to finished product.

FIG. 1 is a cross-section of a typical prior art corn kernel 100. The corn kernel 100 comprises the outer hull or pericarp 110 that protects the seed. The pericarp 110 resists water, water vapor, and is undesirable to insects and micro organisms. The endosperm 120 accounts for about 80% of the kernel's dry weight and comprises about 88% starch and about 8% gluten protein, with the remainder comprising small amounts of oil, minerals, fiber, and ash. The germ 130 is the only living part of the field corn kernel. The germ 130 comprises the genetic information, enzymes, vitamins, and minerals for the kernel to grow into a corn plant. Table 1 below depicts the composition of the major components of a typical corn kernel.

TABLE 1
Corn Kernel Composition (% on dry basis)

| | | | | Fiber & | | |
|---|---|---|---|---|---|---|
| Part | Starch | Fat | Protein | Other | Sugars | Ash |
| Whole | 73.4 | 4.4 | 9.1 | 9.8 | 1.9 | 1.4 |
| Kernel | | | | | | |
| Endosperm | 87.6 | 0.8 | 8.0 | 2.7 | 0.6 | 0.3 |
| Germ | 8.3 | 33.2 | 18.4 | 18.8 | 10.8 | 10.5 |
| Pericarp | 7.3 | 1.0 | 3.7 | 86.9 | 0.3 | 0.8 |
| Tip cap | 5.3 | 3.8 | 9.1 | 78.6 | 1.6 | 1.6 |

As shown in the Table, the germ 130 comprises about 18% protein, and about 33% corn oil, which is high in polyunsaturated fats. The tip cap 140 attaches the kernel to the cob and is the only area of the kernel not covered by the pericarp 110.

The corn from corn tortilla chips such as those in the snack food industry is sometimes cooked and soaked prior to being made into a flour, dough, or masa. One example of this process is the treatment of corn in a nixtamalization process—the traditional method for processing fresh corn to form masa dough. This process dates back to the pre-Columbian era of the Aztec and Maya people in Mesoamerica. In the traditional nixtamilization process, fresh or ‘viable’ whole-kernel corn is first soaked in a solution of water and lime (calcium hydroxide) and then partially cooked at or near the boiling point for a short time depending on the hardness of the corn.

The corn milling industry typically processes viable corn seed corn because the processors believe that the viable seed corn results in improved meal quality and higher yield because when the seed corn is viable, it is relatively easier to separate the various corn fractions, e.g., the pericarp, germ and endosperm, from one another during the milling process. Such separation may be enhanced by an enzymatic relationship between the germ and the endosperm that is not present in ‘dead’ or non-viable seed.

The cooked corn is then steeped in the limewater solution and is allowed to cool and hydrate for about 8-18 hours in order to loosen and degrade the pericarp 110, which is the outer, fibrous layer of a corn kernel. Cooking and steeping in alkaline solution causes partial dissolution of the cuticle and other pericarp layers 110 as well as swelling and weakening of cell walls and fiber components. Lime loosens the pericarp 110 from the endosperm 120 so that water can reach the starch and so that the pericarp 110 can be removed. If the pericarp 110 remains, doughs made from the steeped whole grains become excessively sticky and are difficult to sheet/form into desired shapes. The corn kernels generally have a moisture content of at least about 50% by weight by the end of the steeping step. The heating and steeping steps result in hydration and partial hydrolysis of the pericarp 110. The corn kernels are then drained of the cooking liquor (called “nejayote”), which contains loosened pericarp 110 and other dissolved or suspended particles, including portions of the germ 130. The corn kernels are then washed to remove excess lime and loose particles. The washing may be performed with jets of water which also remove any remaining lime. Typically, in present art processes, up to 15% by weight of the total corn fraction is lost during the cooking and washing steps. Most of the corn fraction lost consists of the pericarp 110, the germ 130, and the tip 140. The washed kernels are then ground in a stone mill to disrupt the starch-containing cell structures and cause the mixture to form a dough. The ground, wet mixture can be mixed with water to form fresh masa containing about 50% or more moisture, or it can be dehydrated to form dry masa flour. Dry masa flour can be rehydrated at a later time to form masa dough that can be thermally processed into a shelf-stable, ready to eat food product as any other snack food dough is processed in the art. For example, the dough can be extruded or sheeted and then cut into snack food pre-forms.

Because many consumers also prefer corn chips having a toasted corn flavor rather than chips having a light corn flavor, the prior art, non-roasted corn pre-forms require a toasting step similar to that described in U.S. Pat. No. 4,122,198. Pre-forms are typically toasted in a three-pass toast oven at between about 400° F. and about 750° F. for about 30 seconds to achieve a moisture content of between about 25% and about 40% by weight. Toasting of the pre-forms imparts a toasted corn flavor and also creates toast points. One problem with toasting the prior art, non-roasted corn masa is that the toasting process is very difficult to control. The belt temperature on which the pre-forms are toasted must be run at temperatures upwards of 700° F. to get the toasted corn flavor. However, toast points are often created at much lower belt temperatures of 550 to 570° F., and at higher temperatures the pre-forms can acquire too many and/or too dark toast points. Consequently, operators must struggle with adjusting the temperature to balance the appropriate toasted flavor with the appropriate toast points. This balancing can occur by changing the temperature and these temperature changes can in turn create varying degrees of “toasted” flavor and, sometimes undesirable burnt or an overtoasted appearance. Consequently, the prior art process requires careful balancing to impart enough heat to toast the pre-forms, but not so much heat that would cause the pre-form to looked scorched or burnt.

### SUMMARY OF THE INVENTION

The present invention is directed towards neutralizing enzymes in corn. In one aspect, the process comprises the steps of removing the outer pericarp layer from a corn kernel and roasting the remaining corn product. In one aspect, the process comprises roasting corn, cooking the roasted corn, steeping the roasted corn, washing the roasted corn to remove the pericarp layer and grinding the roasted corn to make a roasted masa dough. In one aspect, sufficient roasting occurs to reduce the final level acrylamide in a food product. In one aspect, the present invention provides a greater conversion of the corn kernel to a finished product, such as a tortilla chip. The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a cross-section of a typical prior art corn kernel; and

FIG. 2 shows a schematic representation of one embodiment of the present invention.

### DETAILED DESCRIPTION

FIG. 2 shows a schematic representation of one embodiment of the present invention. The process starts with roasting the corn by, for example, routing the corn through a gas fired impingement oven 210, or other equivalent means. In an alternative embodiment, a fluidized bed dryer, or drum dryer/roaster 210 can be used to for roasting corn. As used herein, “roasting corn” is defined as the non-aqueous heating of corn kernels to a corn temperature and for an amount of time that neutralizes the corn seed so that the corn seed is no longer viable and includes, but is not limited to microwave heating, infrared radiant heating, oven heating, and pulsed electric field heating. Because the definition of roasting corn above is not based upon any changes to the pericarp, the pericarp is not necessary for the roasting step. Consequently, in one embodiment, the pericarp layer is removed (e.g., pearled, scarified, or mechanically) to form a remaining corn product and the remaining corn product is roasted.

As used herein, the phrase “neutralizes the corn seed” means that under conditions conducive to growth, at least about 50 percent of the seeds in the support fail to germinate and start growth above the surface of the seed support. A seed support has several characteristics. It typically forms a web or strip of a matrix support. The support physically contains and retains the seed and additives at least until the support is positioned where germination and subsequent growth of the plant is desired. While 50 percent may be regarded as the minimum acceptable, desirably, at least about 65 percent of the seeds fail to germinate and start growth above the surface of the support, while preferably, at least about 80 percent of the seeds in the support germinate and start growth above the surface of the support, and more preferably, at least about 90 percent of the seeds in the support fail to germinate and start growth above the surface of the support.

An experiment was conducted to determine some time and temperature relationships that neutralized the corn seed. Five fractions of 8 kernels of dent grain corn were subjected to the following controlled temperature ranges for 15 minutes: 25° C. (ambient), 40° C., 60° C., 100° C., and 140° C. Next, each of the samples was planted in a Styrofoam cup filled with earth from a flower bed and holes were put in the cup to facilitate drainage. Approximately 100 mL of water was supplied to each sample and the excess water that drained was discarded. The cups were placed in sunlight and watered every 4th day to provide consistent soil moisture in each sample. On day seven, seedlings emerged from each of the eight kernels at ambient, and those heated 40° C. and 60° C. The seedlings were permitted to grow through day 14. Only four of the eight seeds grew from the 60° C. treated samples while all eight grew from the 40° C. and ambient samples. In the 100° C. samples three of the seeds had germinated, but had failed to sprout and grow while the remaining five seeds had deteriorated and decayed or rotted. None of the 140° C. sample seeds had germinated and all had deteriorated or rotted. Consequently, all samples processed above 60° C. for 15 minutes neutralized the corn seed. Thus, in one embodiment, the corn is roasted at a corn temperature of greater than about 60° C. for more than about 15 minutes. In a preferred embodiment, the corn is roasted at temperatures greater than 100° C. (212° F.) for more than 5 minutes and in one embodiment for more than about 15 minutes. Preferably the corn is heated to between about 115° C. to about 205° C. and more preferably 140° C. to about 180° C. for between about 5 minutes and about 20 minutes.

After roasting the corn, the roasted corn, 1-5% lime, and water are next placed into a steam-jacketed kettle 220. This mixture is then heated to its cook temperature by use of a steam jacket to near boiling. Once the target temperature is reached, the corn, lime, and water mixture is cooked at the cook temperature for a set number of minutes. Following the cook, fresh water is added to the kettle 220 to cool the batch. The kettle of corn-slurry is then pumped to a soak tank 230 to be “steeped” or soaked. After the corn-slurry has been in the soak tank 230 for about 8-18 hours, the slurry is pumped to a corn hopper 240. The corn hopper 240 separates corn and water. A screw auger 250 then feeds the corn-slurry into a washer 260. The washer 260 is a rotating drum that utilizes a fresh wash water stream to rinse the corn of pericarp, lime, and other dissolved or suspended particles. When the corn kernels are roasted prior to cooking in lime, a greater percentage of the germ advantageously adheres to the endosperm and is carried into the process. As a result, less of the germ and slightly less pericarp is lost in the nejayote and more of the corn kernel is converted into the finished product resulting in an upside conversion efficiency and reduced waste.

From the washer 260, the corn is sent to a drain belt 270 to drain excess water. The corn is then sent to further processing 280 where it is made into a product such as a roasted masa flour that can be later rehydrated, or a roasted masa dough that can be thermally processed into a shelf-stable, ready to eat food product as any other snack food dough is processed in the art. For example, the dough can be extruded or sheeted and then cut into snack food pre-forms. The pre-forms can be optionally toasted, and can then be sent through a proofing stage where toasted pre-forms are exposed to ambient air for about 2 to 15 minutes to equilibrate moisture throughout the chip. The pre-form can then be thermally processed to a moisture content of less than about 5% by weight and more preferably less than about 2% by weight into a shelf stable food product. As used herein, “shelf stable food product” refers to a food product that may be stored without refrigeration for at least one week and that is in ready to use consumable form and requires no additional cooking prior to consumption by a consumer. Examples of such food products that can be made by the present invention include taco and tostada shells, corn chips, and tortilla chips.

In one embodiment, the thermal processing comprises frying and the pre-form is fried in a conventional tortilla chip fryer at about 340° F. to about 360° F. or other temperature until a moisture content of between about 0.8% to about 2.0% by weight and more preferably about 1.0% by weight is achieved. The fried snack chip can then be seasoned in a seasoning tumbler and then packaged.

One advantage of the present invention over the prior art is that whereas prior art chips required the toasting step to impart a toasted flavor, the toasted flavor made from a chip of the present invention is independent of the toasting step. Consequently, the pre-forms can be toasted solely for purposes of creating toast points without worry of imparting the requisite toasted flavor. Further, because the toasting step is no longer required to impart a toasted flavor, a tortilla chip can be made having a toasted flavor with no toast points.

One benefit of roasting the corn is the end flavor it provides to both baked and fried chips. Regarding baked chips, the toasted or untoasted pre-form can be baked in an oven to produce a low-fat snack food. As disclosed in U.S. Pat. No. 3,578,463, enzymes must be deactivated in corn to avoid a cob-like flavor. The enzymes must be deactivated to avoid undesirable earthy green flavors. The enzymes can be destroyed if the corn reaches specific temperatures for a specific time. Enzyme destruction can occur while corn is cooking in the kettle, however, because ambient water in the center of the kettle enters the kettle much cooler as fresh kettle water and because mixing in the kettle is done in a very gentle manner, a temperature gradient can exist in the kettle. Consequently, the temperature gradient results in some uneven cooking, and uneven enzyme deactivation. As a result, baked chips often have an undesirable earthy green flavor notes. Such flavor notes are advantageously not present in baked chips made from the present invention. Without being bound to theory it is believed that the roasting step itself, or the effects of the roasting step upon subsequent cooking in the kettle helps to inactivate degradative enzymes that can cause undesirable earthy green flavors. For example, the roasting of the corn kernel may destroy the degradative enzymes. Alternatively, it has been found that the roasted corn kernels hydrate more efficiently than non-roasted corn kernels. An experiment was conducted whereby a sample of unroasted and roasted corn kernels were hydrated in 1% lime solution at 60° C. for eight hours. At the end of eight hours, the unroasted corn comprised 37% water by weight and the roasted corn comprised 42% water by weight. Thus, because the roasted corn hydrates quicker, it can be cooked more efficiently and this more efficient cooking may help to destroy more degradative enzymes. Consequently, the present invention provides a way to reduce the off-flavors in baked products.

Further, roasting the corn also provides superior end flavor to both baked and fried chips because the toasted flavor can be imparted into the masa dough pre-form independent of the toasting step. Thus, a very consistent toasted corn flavor can be provided. The roasting step advantageously results in finished product attributes with a flavor profile that was reminiscent of coffee type flavor development. Flavor notes were noticeably more roasted with a slightly bitter back note. The texture was slightly harder, more dense and had a lower blister development than a prior art tortilla chip made from unroasted corn kernels. While these features were characteristic of the demonstration, it is expected that adjustments of the process conditions in milling and toasting can be made to encompass a wide array of different product attributes.

Further, the degree of roast can be dialed in as desired by using a blended masa made from combining roasted and unroasted corn and/or from combining roasted and unroasted masa into a masa blend. Thus, the blended masa can be made by mixing roasted and unroasted corn during the kettle cooking step, or alternatively, the roasted corn masa can be mixed with unroasted corn masa. Further, the roasted corn itself can comprise a blend of corn roasted for various times and temperatures. For example, the pre-form can comprise 30% of corn roasted at 140° C. for 10 minutes and 70% unroasted corn. Consequently, in one embodiment, unroasted corn is cooked with roasted corn in the kettle. In one embodiment, the pre-form comprises 40% of corn roasted at 180° C. for 15 and 60% unroasted corn. Alternatively, the pre-from can comprise 100% of corn roasted at 185° C. for 15 minutes to provide a very chocolately appearing finished chip with yellow flakes. Consequently, in one embodiment, the roasted blends can be used to impart certain, desired visual cues.

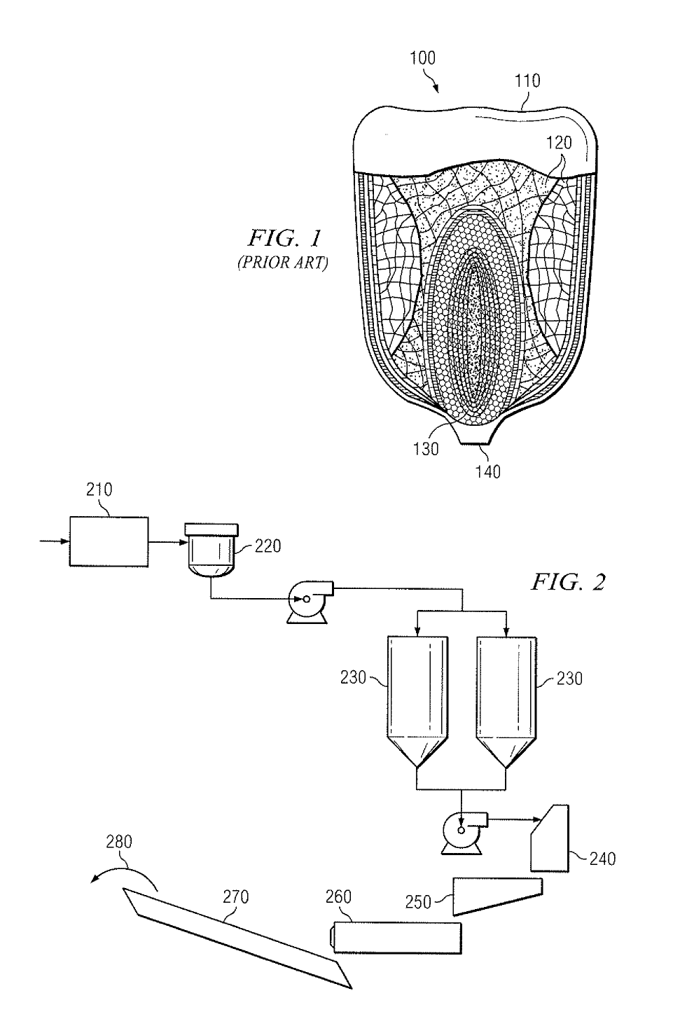

Because the heating of food products at low moisture content is believed to result in increased levels of acrylamide, raw corn and corn roasted at 180° C. for 15 minutes was submitted for acrylamide analysis. The raw corn revealed an acrylamide concentration of 61.6 ppm and the roasted corn had a concentration of 45.5 ppm. Similarly, a fried tortilla chip made from roasted corn kernels was submitted for acrylamide analysis. Surprisingly, in one embodiment, a tortilla chip made from 100% corn kernels roasted at 180° C. for 15 minutes had an acrylamide concentration of 104 ppm whereas a similarly processed tortilla chip made from unroasted corn (control batch) had an acrylamide concentration of 280 ppm. Consequently, in one embodiment, roasting occurs in an amount sufficient to reduce the final level of acrylamide in a food product to a level that is lower than a control batch, wherein said control batch comprises no roasting step. Similar results were subsequently demonstrated at toasting conditions of 140° C. for 10 minutes. While the exact mechanism for the reduction of acrylamide is not known, one theory is that the roasting, which causes a longitudinal surface crack through the pericarp in the corn kernel preferentially heats the germ 130, as depicted in FIG. 1, and degrades the acrylamide pre-cursors. In the case of corn this may come from a combination of carmelization of the reducing sugars required for acrylamide formation and a degradation of asparagine due to the heating of the germ 130.

Another benefit provided by roasting the corn is that a larger percentage of the corn kernel is converted into a final food product. As previously discussed, the corn milling industry typically processes viable corn seed corn because the processors believe that the viable seed corn results in improved meal quality and higher yield because when the seed corn is viable, it is relatively easier to separate the various corn fractions from one another during the milling process. This roasting step, on the other hand, which occurs prior to cooking and while the corn lacks sufficient moisture to allow gelatinization of starches makes it possible to separate the two events of neutralizing enzymes and hydrating/gelatinizing the starch. When the corn seed is neutralized prior to the cooking and steeping step, a larger portion of the germ remains with the endosperm during the washing step. Consequently, the conversion of corn kernel to finished product increases by about 1%. Further, as previously discussed, the germ 130 comprises about 33% corn oil. Thus, less oil is required to fry the roasted dough pre-form of the present invention than is required by non-roasted corn. Further, the corn oil from the germ results in a fried chip having a higher natural oil content than a fried chip not using roasted corn. In addition, because the germ 130 comprises 18% protein, 19% fiber/other, and 10.5% ash, the resultant roasted masa dough comprises a higher protein and fiber content.

While this invention has been particularly shown and described with reference to a preferred embodiment, it will be understood by those skilled in the art that various changes in form and detail may be made therein without departing from the spirit and scope of the invention.

What is claimed is:

1. A process for processing corn to make an enhanced food product, comprising the steps of
a) roasting corn having an outer pericarp layer, a germ, and endosperm to produce roasted corn;
b) cooking said roasted corn in an alkaline solution;
c) steeping said roasted corn;
d) washing said roasted corn to remove said pericarp layer; and
e) grinding said roasted corn to make a roasted masa dough.

2. The process of claim 1 further comprising a blended masa.

3. The process of claim 1 further comprising the step f) of dehydrating said roasted masa dough into a roasted masa flour.

4. The process of claim 1 further comprising the step f) of forming said roasted masa dough into pre-forms.

5. The process of claim 4 further comprising the step g) of thermally processing said pre-forms to make a shelf-stable food product.

6. The process of claim 5 wherein said thermal processing at step g) further comprises the step of baking said pre-forms a shelf-stable food product.

7. The process of claim 5 wherein said thermal processing at step g) further comprising the step of toasting said pre-forms followed by the step of frying said pre-forms.

8. The process of claim 5 wherein said thermal processing at step g) further consisting of the step of frying said pre-forms to make a shelf-stable food product.

9. The process in claim 5 wherein said roasting occurs in an amount sufficient to reduce the final level of acrylamide in said food product to a level that is lower than a control batch, wherein said control batch comprises no roasting step.

10. The process in claim 1 wherein said roasting at step a) cracks said pericarp layer to permit said alkaline solution in step b) to contact said germ and said endosperm.

11. The process in claim 1 wherein said roasting at step a) occurs at greater than 100° C. for greater than 5 minutes.

12. The process in claim 1 wherein said roasting at step a) occurs at between about 115° C. and about 205° C. for between about 5 minutes and about 20 minutes.

13. A process for neutralizing enzymes in corn, comprising the steps of;
a) removing an outer pericarp layer from a corn kernel to form a remaining corn product; and
b) roasting said remaining corn product.

14. The process in claim 13 wherein said roasting at step b) occurs at greater than 100° C. for greater than 5 minutes.

15. The process in claim 13 wherein said roasting at step b) occurs at between about 115° C. and about 205° C. for between about 5 minutes and about 20 minutes.
